(19) United States
(12) Patent Application Publication
(10) Pub. No.: US 2014/0327540 A1
(43) Pub. Date: Nov. 6, 2014

(54) MOBILE PERSONAL EMERGENCY RESPONSE SYSTEM

(71) Applicant: anyDATA Corporation, Irvine, CA (US)

(72) Inventors: Soon Bum Shin, Irvine, CA (US); Chilsam Lee, Irvine, CA (US)

(21) Appl. No.: 14/271,220

(22) Filed: May 6, 2014

Related U.S. Application Data
(60) Provisional application No. 61/819,930, filed on May 6, 2013.

(51) Int. Cl. G08B 21/02

(52) U.S. Cl. CPC G08B 21/02
USPC 340/539.11

(57) ABSTRACT

A wireless device includes a transceiver configured to communicate with a device management center, a first sensor configured to detect a condition associated with the wireless device, a second sensor configured to detect a position associated with the wireless device, and a processor coupled to the transceiver, the first sensor, and the second sensor. The processor is configured to determine an abnormal condition related to the wireless device by receiving a first output from one of the first sensor and the second sensor, and comparing the first output to a threshold value, and send an alert message to a device management center including information related to the abnormal condition.

### BACKGROUND

The present invention relates to personal emergency response systems. More particularly, embodiments of the invention relate to systems in which a portable wireless device is activated to indicate an emergency situation with respect to a person.

### SUMMARY

Personal emergency response systems are useful when attempting to care properly for an elderly person, a child, or other person who may require assistance during an emergency situation. The elderly, who constitute a globally rising population, often suffer from one or several health problems, which make the elderly population particularly prone to emergencies. For example, coronary heart disease, strokes, accidents that results in significant injury, and fading memory often affect the elderly population. The infrastructure to care for the elderly has, in general, lagged behind the increase in elderly population. In fact, more and more elderly people live alone. As a sad consequence, instances where elderly people die alone and are not found promptly have increased. Other population groups such as, for example, children are also highly prone to accidents. Embodiments of the invention provide, among other things, a system configured to provide an easy and convenient way to permit an elderly person, a child, or other person to communicate the existence of an emergency situation.

In one embodiment, the invention provides a wireless device including a transceiver configured to communicate with a device management center, a first sensor configured to detect a parameter associated with the wireless device, a second sensor configured to detect a position associated with the wireless device, and a processor. The processor is coupled to the transceiver, the first sensor, and the second sensor and is configured to determine an abnormal condition related to the wireless device by receiving a first output from one of the first sensor and the second sensor, and comparing the first output to a threshold value. The processor is also configured to send an alert message to a device management center. The alert message includes information related to the abnormal or emergency condition.

In another embodiment, the invention provides a personal emergency system including a wireless device and a remote server. The wireless device includes a first transceiver, a first sensor configured to detect a parameter associated with the wireless device, a second sensor configured to detect a position associated with the wireless device, and a first processor coupled to the transceiver, the first sensor, and the second sensor. The first processor is configured to receive an output from one of the first sensor and the second sensor, determine if an abnormal condition exists based on the output, and generate an alert message when the abnormal condition exists. The remote server includes a second transceiver configured to communicate with the wireless device. The remote server also includes a database populated with information associated with a user of the personal emergency system, and a second processor coupled to the database and the second transceiver. The second processor is configured to receive the alert message from the wireless device that includes information regarding the abnormal condition. The second processor is also configured to access the database based on the alert message.

Other aspects of the invention will become apparent by consideration of the detailed description and accompanying drawings.

### BRIEF DESCRIPTION OF THE DRAWINGS

FIG. 1 illustrates a personal emergency response system according to one embodiment of the invention.

FIG. 2 is a schematic diagram of a wireless device and a docking station of the personal emergency response system of FIG. 1.

FIG. 3 is a diagram illustrating a communication range between the wireless device and the docking station of FIG. 2.

FIG. 4 is a flowchart illustrating a method of determining an abnormal condition associated with the wireless device of the FIG. 2.

FIG. 5 is a schematic diagram of a remote server of the personal emergency response system of FIG. 1.

FIG. 6 illustrates an exemplary screenshot of a portion of a GUI designed to be presented to a user or operator located at a device management center of the personal emergency response system of FIG. 1.

FIG. 7 illustrates a detail screen or a portion of a GUI designed to be presented to a user or operator located at the device management center.

FIG. 8 is a schematic diagram of a recipient device of the personal emergency response system of FIG. 1.

FIG. 9 illustrates an exemplary screenshot of the recipient device.

FIG. 10 illustrates an exemplary map view shown on the recipient device.

FIG. 11 is a flowchart illustrating a method of operating the personal emergency response system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. In addition, the description that follows explains the components and operations of exemplary embodiments of the invention. No particular component or aspect of the exemplary embodiments described should be considered essential to the invention unless the text of this detailed description explicitly indicates otherwise.

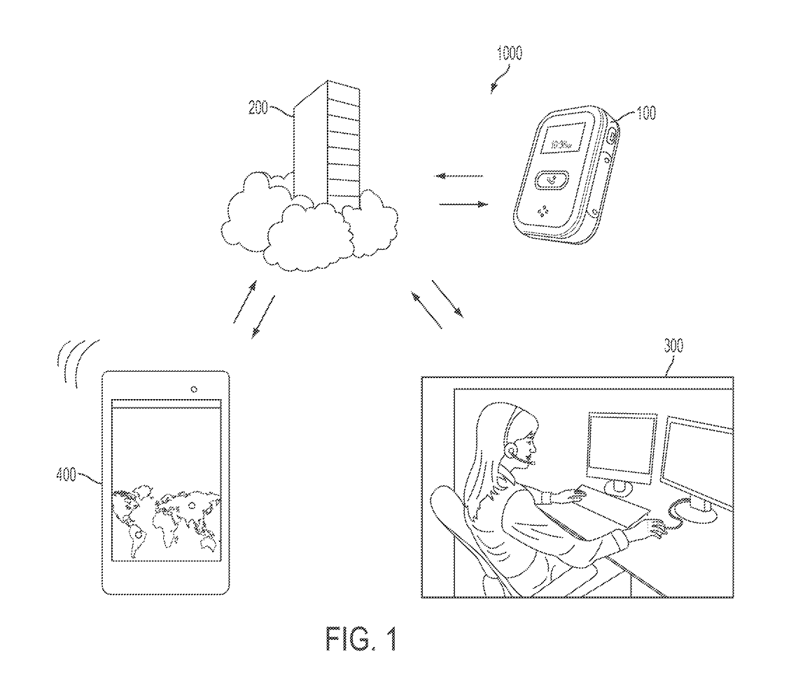

FIG. 1 illustrates a personal emergency response system 1000. The emergency response system 1000 provides emergency call services to connect a user to family, friends, and/or neighbors who may provide immediate help, and shares the user's status with family, friends, neighbors, and other community service organizations. In some embodiments, the emergency response system 1000 also provides concierge services for the user. The emergency response system 1000 includes a wireless device 100, a remote server 200, a device management center 300, and a recipient device 400. The wireless device 100 is, preferably, a relatively small, portable device such as a wearable electronic device or a fob. The wireless device 100 automatically or upon user activation notifies the device management center 300 that the user needs assistance. For example, if the user falls and cannot get back up, the wireless device 100 communicates with the device management center 300 through the remote server 200. The device management center 300 is configured to access the remote server 200 and identify the user associated with the wireless device 100 to determine an appropriate action. The remote server 200 stores information related to the wireless device 100 associated with the user (e.g., a device serial number), information (e.g., name and contact information) related to family members or other recipients to be notified when the user is in an emergency situation, telephone numbers for local emergency response agencies (e.g., police, ambulance, fire department, etc.), and the like. By accessing the remote server 200, the device management center 300 gains access to personal information associated with the user and is able to better assist the user during an emergency situation. In some situations, the device management center 300 determines that a recipient associated with the user is to be contacted. The device management center 300, in such situations, contacts a particular recipient based on, for example, the type of emergency, the time of day, and the like. The remote server 200 can be also accessed through the recipient device 400. The recipient device 400 is an electronic device configured to connect to the remote server 200, for example a desktop computer, a smartphone, a tablet computer, or the like. The recipient device 400 obtains information about the user of the wireless device 100 by accessing the remote server 200. For example, the recipient device 400 may display information regarding the activity of the user, location of the user, and the like. Thus, a recipient can receive a status regarding the user even when an emergency situation does not exist.

The wireless device 100 may be configured in multiple fashions. For example, in one embodiment the wireless device 100 is configured as a wearable electronic device. In such an embodiment, the wireless device 100 may include an attachment device configured to secure the wireless device 100 to a user, for example, a wrist band to secure the wireless device 100 to a user's wrist. In other embodiments, the wireless device 100 includes a necklace or other band to secure the wireless device 100 to a user's neck. In yet other embodiments, instead of or in addition to being configured to being worn on the body the wireless device 100 is designed to be non-wearable and instead, for example, carried or fit in a pocket of an article of clothing such as a shirt pocket or pants pocket.

The wireless device 100 includes a plurality of sensors that monitor parameters associated with the wireless device 100 to infer information regarding the user. The wireless device 100 determines an abnormal condition related to the wireless device 100 based on the outputs or information from the various sensors. The abnormal condition of the wireless device 100 can, in some instances, be used to infer information regarding the user. Also, in some embodiments, the abnormal condition is directly associated with the user (e.g., high body temperature). In the illustrated embodiment, the wireless device 100 couples with a docking station 104. The docking station 104 may be positioned in a convenient location in the user's place of residence (i.e., the user's home). The docking station 104 is configured to charge the wireless device 100 by providing a charging current.

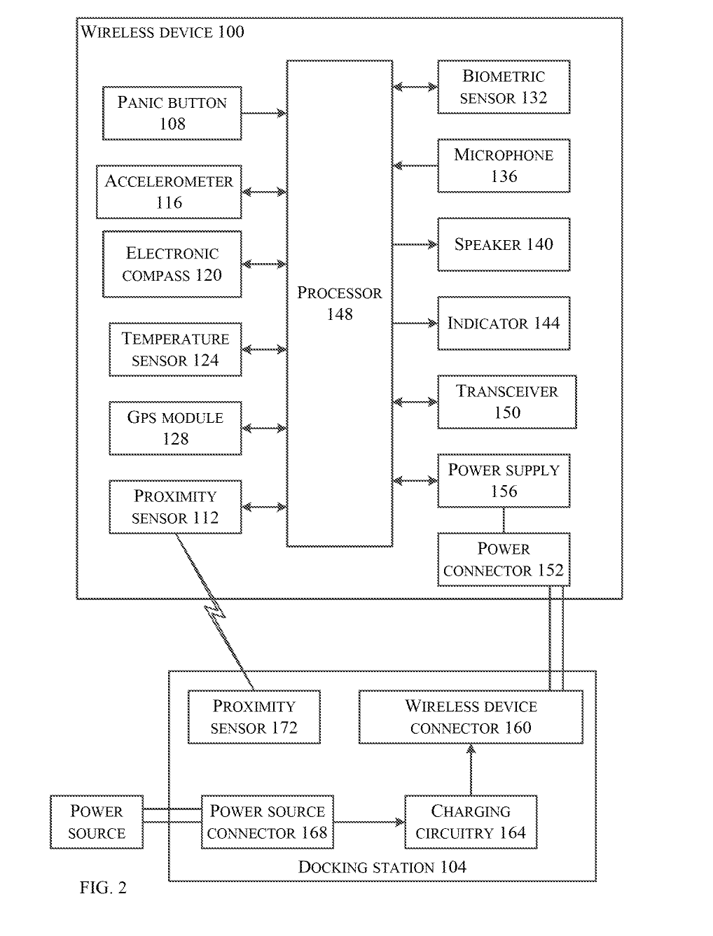

In the embodiment shown in FIG. 2, the wireless device 100 includes a panic button 108, a proximity sensor 112 (e.g., a first sensor), an accelerometer 116 (e.g., a second sensor), an electronic compass 120 (e.g., a third sensor), a temperature sensor 124 (e.g., a fourth sensor), a GPS module 128 (e.g., a fifth sensor), a biometric sensor 132 (e.g., a sixth sensor), a microphone 136, a speaker 140, an indicator 144, a processor 148, a transceiver 150, a power connector 152, and a power supply 156. The power supply 156 provides power to the sensors 112, 116, 120, 124, 128, 132, the microphone 136, the speaker 140, the indicator 144, and the processor 148. The power supply 156 is, for example, a battery. In the illustrated embodiment, the battery 156 is a rechargeable battery. The power connector 152 is configured to connect to a charging cable and/or the docking station 104 to receive a charging current from an external power source (e.g., a wall outlet). The transceiver 150 is coupled to the processor 148 and is configured to send and receive messages to and from the remote server 200.

As shown in FIG. 2, the docking station 104 includes a wireless device connector 160, charging circuitry 164, a power source connector 168, and a proximity sensor 172. The power source connector 168 is coupled to the external power source to receive power. The wireless device connector 160 is configured to connect to the power connector 152. When configured in the form of a battery, the power supply 156 of wireless device 100 is charged via a current provided by the charging circuitry 164. In some embodiments, the charging circuitry 164 is included in the wireless device 100 and the docking station 104 passes and conditions (e.g., via a voltage converter) power from the external power source (e.g., a wall outlet) to the wireless device 100 in a form usable by the wireless device 100.

The proximity sensor 172 of the docking station 104 may include, for example, an RF sensor. The proximity sensor 172 communicates with the proximity sensor 112 of the wireless device 100. The wireless device 100 may be configured to detect when the wireless device 100 is positioned outside of a communication range between the wireless device 100 and the docking station 104. The wireless device 100 may be move a distance away from the docking station 104, for example, when the wearer walks away from the docking station 104. The proximity sensor 172 of the docking station 104 and the proximity sensor 112 of the wireless device 100 can be configured to have different communication ranges for different applications. In other words, the proximity sensors 112, 172 can be configured to communicate with each other when the proximity sensors 112, 172 are, for example, 5 feet apart. In other embodiments the proximity sensors 112, 172 communicate over larger distances, for example, 50 feet apart. When the proximity sensors 112, 172 are separated by a distance larger than the maximum distance or communication range (e.g., 50 feet apart), the proximity sensors 112, 172 cannot communicate with each other. Thus, the wireless device 100 determines when the maximum distance (e.g., 50 feet) between the proximity sensor 112 and the proximity sensor 172 is exceeded.

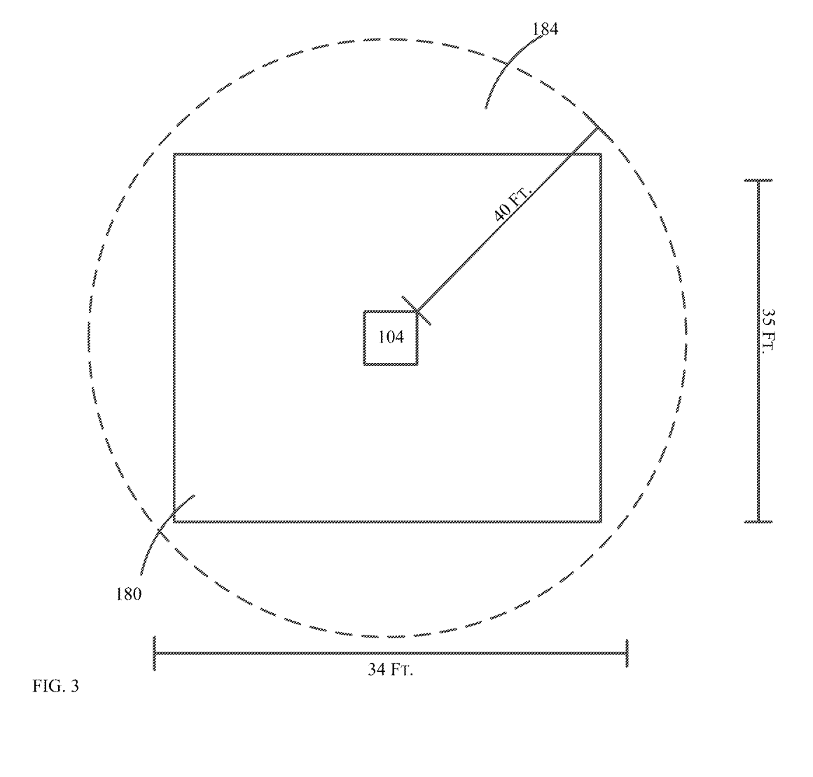

As shown in FIG. 3, the maximum distance can be based on the user's place of residence. In other words, the maximum distance may be set such that when the user leaves the user's home 180, the maximum distance is exceeded, but when the user remains in the user's home, the maximum distance is not exceeded. In the illustrated embodiment, the user's home measures approximately 1200 square feet and the docking station 104 is positioned close to the center of the user's home. If the proximity sensor 172 of the docking station 104 and the proximity sensor 112 of the wireless device 100 have a range of approximately 40 feet, the reception area 184 is defined by a circular perimeter centered on the docking station 104. As shown in the illustrated embodiment, the reception area 184 is slightly larger than the user's home area. Thus, while the wireless device 100 remains within the user's home, the proximity sensors 112, 172 are able to communicate with each other. However, when the wireless device 100 is taken outside of the user's home, presumably by the user, the distance between the proximity sensors 112, 172 will exceed the maximum communication range or distance (e.g., 40 feet) and the proximity sensors 112, 172 do not communicate with each other. Thus, the wireless device 100 determines when the wireless device 100 is outside of the user's home because the proximity sensor 112 does not communicate with the proximity sensor 172 of the docking station 104.

The proximity sensor 112 is coupled to the processor 148 and sends an output to the processor 148 indicative of a relative proximity to the docking station 104. The proximity sensor 112 may include an RF transmitter. Based on the output the processor 148 receives from the proximity sensor 112, the processor 148 determines whether the wireless device 100 is still within the user's home. When the distance between the proximity sensor 172 of the docking station 104 and the proximity sensor 112 of the wireless device 100 exceeds the maximum distance and the sensors 112, 172 cease to communicate with each other, the information from the sensor 112 changes and the processor 148 determines that the user has most likely left the user's home.

The accelerometer 116 is configured to detect movement of the wireless device 100. The accelerometer 116 is coupled to the processor 148 and sends an output indicative of acceleration (e.g., movement) of the wireless device 100 to the processor 148. Since the user of the wireless device 100 is in close proximity to the wireless device 100 (e.g., the user wears and/or carries the wireless device 100) detecting movement of the wireless device 100 infers information regarding movement of the user. In some embodiments, the accelerometer 116 is used as a pedometer to calculate the number of steps taken by the user. By using the accelerometer 116, the processor 148 determines the level of activity of the user. When the output from the accelerometer 116 is too high (e.g., the wireless device 100 moved “too quickly”), the processor 148 may determine that the wireless device 100 and/or the user has been subject to a sudden impact, for example, if the user falls, hits the ground, runs into an object, or has been hit by an object.

The electronic compass 120 is coupled to the processor 148 and is configured to send an output to the processor 148 indicative of an angular position and movement of the wireless device 100. The electronic compass 120 may include a magnetometer that detects changes in the angular position of the wireless device 100. For example, the processor 148 differentiates between a user standing and a user laying down based on the output from the electronic compass 120. In other embodiments, the electronic compass 120 may include a fiber-optic gyrocompass to detect direction (e.g., angular position) of the wireless device 100.

The temperature sensor 124 is coupled to the processor 148 and is configured to send an output to the processor 148 indicative of a measured ambient temperature surrounding the wireless device 100. The temperature sensor 124 includes, for example, a thermistor. In other embodiments, the temperature sensor 124 includes another type of temperature responsive material. In the illustrated embodiment, the processor 148 determines when the ambient temperature is outside recommended or typical temperature ranges for the user based on the output from the temperature sensor 124.

The GPS module 128 is coupled to the processor 148 and is configured to determine a position (i.e., location) and movement of the wireless device 100. The GPS module 128 sends the location and movement information to the processor 148. The processor 148 may determine when a user leaves a predetermined area based on the information from the GPS module 128.

The biometric sensor 132 is coupled to the processor 148 and is configured to determine a biometric characteristic associated with the user of the wireless device 100 and provide a biometric output to the processor 148. The biometric sensor 132 includes, for example, a heart rate sensor to determine the heart rate of the user. In other embodiments, the biometric sensor 132 includes a temperature sensor configured to determine a body temperature associated with the user. In yet other embodiments, the biometric sensor 132 includes a blood pressure sensor to determine a blood pressure associated with the user.

The microphone 136 is coupled to the processor 148 and is configured to receive sound signals from the user. For example, in some embodiments, after the wireless device 100 sends an alert message to the device management center 300, the microphone 136 is automatically activated. In such situations, the user may explain what the emergency situation is and relate any pertinent information to the device management center 300. The speaker 140 is configured to play sound signals. For example, the speaker 140 may play an alert sound when the state-of-charge of a battery of the wireless device 100 is below a predetermined threshold to alert the user to change the battery. In some embodiments, the microphone 136 and the speaker 140 are configured to enable two-way communication between the user of the wireless device 100 and the device management center 300 when an alert message is sent to the device management center 300.

Aside from the speaker 140, the user can be alerted with the indicator 144, as shown in FIG. 2. The indicator 144 may be a light-emitting diode (LED), an LCD display, an LED display, or other visual device or devices. The indicator 144 is activated by the processor 148 to alert the user, for example, that a battery of the wireless device 100 is low. The indicator 144 may, additionally or alternatively, indicate a time of day, number of steps taken by the user, weather, a map, and the like. The indicator 144 presents information regarding, for example, the wireless device 100 (e.g., low battery alert), the user (e.g., number of steps taken), and the like to the user.

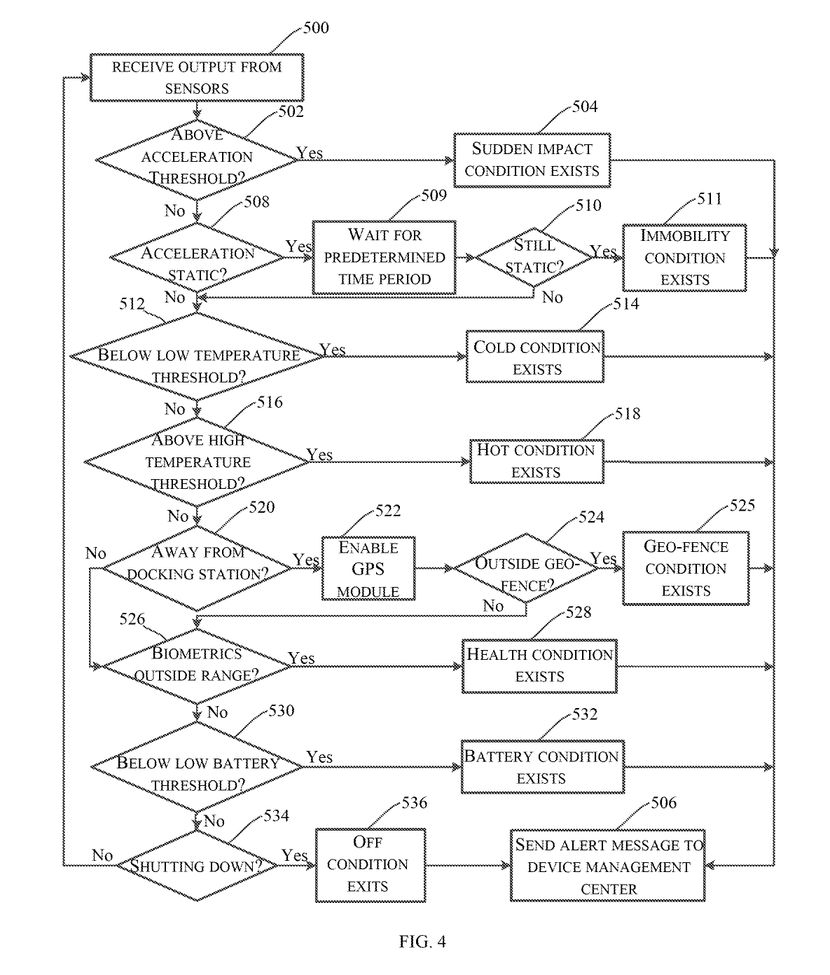

The processor 148 is coupled to the panic button 108, the proximity sensor 112, the accelerometer 116, the electronic compass 120, the temperature sensor 124, the GPS module 128, the biometric sensor 132, the microphone 136, the speaker 140, the indicator 144, and the power supply 156. As shown in the flowchart of FIG. 4, the processor 148 receives information from the panic button 108, the sensors 112, 120, 124, 128, 132 (block 500), and the microphone 136. The processor 148 determines the existence of an abnormal condition related to the wireless device 100 based on the output from the sensors 112, 120, 124, 128, 132, and the power supply 156. The abnormal condition related to the wireless device 100 can, sometimes, also be related to a condition of the user. For example, the acceleration experienced by the wireless device 100 is considered to be closely related (e.g., almost equal) to the acceleration experienced by the user wearing and/or carrying the wireless device 100. In other embodiments, however, the abnormal condition related to the wireless device 100 is not indicative of an abnormal condition related to the user. For example, the existence of an abnormal condition is determined when the wireless device is low on battery, which has no correlation to the user. The processor 148 is configured to assume that an output from the panic button 108 (generated when a user activates the panic button 108) means that an abnormal condition exists. The processor 148 sends an alert message to the device management center 300 through the remote server 200 when the processor 148 determines the existence of an abnormal condition.

The processor 148 is configured to determine the existence of a sudden impact condition (e.g., an abnormal condition) indicating that the wireless device 100 suffered a sudden impact or shock due to, for example, a fall. The processor 148 uses the output from the accelerometer 116 and from the electronic compass 120 to determine when a sudden impact condition is present. Since the accelerometer 116 provides information regarding movements of the wireless device 100, the processor 148 compares the output from the accelerometer 116 to an acceleration threshold (block 502). When the processor 148 determines that the output from the accelerometer 116 exceeds the acceleration threshold, the processor 148 determines that the wireless device 100 has been subject to a sudden impact and determines that the sudden impact condition is present (block 504). The sudden impact suffered by the wireless device 100 is indicative of a sudden impact suffered by the user of the wireless device 100. The processor 148 may then determine, for example, that the user has fallen down.

The processor 148 may also determine that the sudden impact condition is present based on the output from the electronic compass 120. Since the electronic compass 120 yields information regarding the angular position of the wireless device 100, the processor 148 may determine, from the output from the electronic compass 120, if the user is lying down. Therefore, the processor 148 may use a combination of the accelerometer 116 output and the electronic compass 120 output to properly determine if the user has fallen and is lying on the ground. When the processor 148 determines that the sudden impact condition is present, the wireless device 100 automatically sends an alert message to the device management center 300 through the remote server 200 (block 506). The processor 148 may also specify in the alert message that the abnormal condition includes determination that the sudden impact condition is present. Thus, if the user falls and is unable to activate the panic button 108 to alert the device management center 300, the wireless device 100 automatically alerts the device management center 300 and help is sent to the user.

The processor 148 is also configured to determine the existence of an immobility condition associated with the wireless device 100. The immobility condition is indicative of a lack of movement of the wireless device 100. The immobility condition indicates (e.g., if the user is wearing and/or carrying the wireless device 100) that the user of the wireless device 100 is suffering from a condition that prohibits movement. For example, the immobility condition indicates that the user is possibly unconscious, seriously injured, or dead. The processor 148 determines the existence of the immobility condition based on the output from the accelerometer 116, the electronic compass 120, the biometric sensor 132, and a timer. For example, based on the output from the accelerometer 116, the processor 148 determines that the wireless device 100 (and thus the user) has not moved by determining whether the signals from the accelerometer 116 are static and have not changed (block 508). The output from the electronic compass 120 indicates whether the user is lying down and can also be used by the processor 148 in combination with the output from the accelerometer 116 to determine more accurately the existence of the immobility condition. The biometric output from the biometric sensor 132 may also be used by the processor 148 to determine the severity of the situation. For example, the biometric sensor 132 may determine that the user no longer has a heart rate, in which case, the user may be dead. In other situations, the biometric sensor 132 determines that the blood pressure of the user is too low or too high and/or that the body temperature of the user is too low (e.g., the user may be dead) or too high (e.g., the user may be seriously ill). The processor 148 may also use a timer to set a predetermined time threshold for which the user remains immobile (block 509). In block 510, the processor 148 then checks again, after a predetermined time has elapsed, if the output from the accelerometer 116 is still static (i.e., the user hasn't moved). If the user remains immobile past the predetermined time threshold, the wireless device 100 sends an alert message to the device management center 300 (block 506). If the processor 148 determines, with or without the timer, that the user is immobile due to death, serious illness, or injury (block 511), the wireless device 100 automatically sends the alert message to the device management center 300. The processor 148 may also specify in the alert message that the abnormal condition includes determination that the immobility condition is present.

In some embodiments, the processor 148 stores certain patterns associated with the user that enable the processor 148 to determine the existence of the immobility condition more accurately. For example, the processor 148 may store a typical time in the morning when the user awakens and begins to move and/or a typical time in the evening when the user goes to bed and stops moving. The processor 148 may also store typical measurements for the user's body temperature, heart rate, and blood pressure so that the processor 148 may determine when the biometric sensor 132 measures an unusually high or an unusually low biometric characteristic.

The processor 148 is also configured to determine the existence of a cold condition and a hot condition indicative of an abnormal ambient temperature for the user. The processor 148 monitors the output from the temperature sensor 124 to determine when the ambient temperature of the wireless device 100 is outside of one or more predetermined ranges. The processor 148 compares the output from the temperature sensor 124 to a low temperature threshold (block 512). When the output from the temperature sensor 124 is below the low temperature threshold, the processor 148 determines that a cold condition is present (block 514). The cold condition may be indicative of, for example, a damaged heating system in the user's home. When the processor 148 determines that the cold condition is present, the processor 148 sends the alert message to the device management center 300 (block 506). The processor 148 may also specify in the alert message that the abnormal condition includes determination that the cold condition is present.

The processor 148 also compares the output from the temperature sensor 124 to a high temperature threshold (block 516). When the output from the temperature sensor 124 exceeds the high temperature threshold, the processor 148 determines that a hot condition is present (block 518). The hot condition may be indicative, in extreme situations, of a fire condition that may be present or imminent. Once the hot condition is determined, the processor 148 sends the alert message to the device management center 300 (block 506). The processor 148 may also specify in the alert message that the abnormal condition includes determination that the hot condition is present. In other words, when the processor 148 determines that the output from the temperature sensor 124 is outside of at least one acceptable range (i.e., below a low temperature threshold or above a high temperature threshold), the processor 148 sends an alert message to the device management center 300 indicating that one of the hot condition and the cold condition is present.

In some embodiments, a clock or timer signal may be combined with the output from the temperature sensor 124 to determine more accurately when a hot condition and a cold condition are present. For example, the processor 148 may determine that the temperature output is below the low temperature threshold, the processor 148 may then monitor how long the wireless device 100 remains in the cold environment. If the wireless device 100 remains in the cold environment for longer than a predetermined time period (e.g., 10 minutes), the processor 148 may then determine that the cold condition is present, which is indicative of, for example, a frostbite condition. In another example, the processor 148 may determine that the output from the temperature sensor 124 exceeds the high temperature threshold. The processor 148 may then monitor how long the wireless device 100 remains in the hot environment. If the wireless device 100 remains in the hot environment for longer than a predetermined time period (e.g., 5 minutes), the processor 148 may then determine that the hot condition is present, which is indicative of, for example, a fire condition. Using a clock or timer signal to determine whether the hot condition and the cold condition are present, allows the processor 148 to ignore temporary temperature changes, and thus, prevents sending false alert messages to the device management center 300. For example, if the user opens the oven and the temperature sensor 124 detects the high ambient temperature from the oven, the wireless device 100 may not generate an alert message (for transmission to the device management center 300) because the opening of the oven is only a temporary and transitory condition.

The processor 148 is configured to determine the existence of a geo-fence condition indicative of the user stepping outside of a predetermined area for the user. The processor 148 monitors the output from the GPS module 128, the accelerometer 116, the proximity sensor 112, and the electronic compass 120 to determine when the geo-fence condition is present. To save energy, when the proximity sensor 112 of the wireless device 100 communicates with the wireless sensor 172 of the docking station 104 (i.e., when the wireless device 100 remains inside the user's home or within a predetermined distance from the user's home), the GPS module 128 is disabled and does not collect location information regarding the wireless device 100. However, once the proximity sensor 112 of the wireless device 100 and the proximity sensor 172 of the docking station 104 fail to communicate because the distance between the proximity sensor 112 of the wireless device 100 and the proximity sensor 172 of the docking station 104 exceeds the maximum distance, the processor 148 determines that the user has left the user's home and the GPS module 128 begins to collect location and movement information for the wireless device 100. Thus, the processor 148 first checks if the wireless device 100 is apart (i.e., not in proximity) from the docking station 104 (block 520).

If the processor 148 determines that the wireless device 100 is away (i.e., farther than the maximum distance) from the docking station 104, the processor 148 enables the GPS module 128 (block 522) and compares the location of the wireless device 100 according to the GPS module 128 with a position threshold associated with a predetermined geo-fence (block 524). The geo-fence establishes a perimeter around a specific area. In some embodiments, the predetermined perimeter may be centered on the user's home or place of work. In other embodiments, the perimeter may be established by city or town limits. The processor 148 determines that the geo-fence condition is present when the processor 148 determines that the position of the wireless device 100 as indicated by the GPS module 128 is outside the predetermined geo-fence (block 525). Then, the processor 148 sends an alert message to the device management center 300 indicating that the geo-fence condition was determined to be present (block 506). If the processor 148, however, determines that the wireless device 100 is not far apart from the docking station 104 (i.e., is within the predetermined distance of the docking station 104), the processor 148 does not enable the GPS module 129.

In some embodiments, once the processor 148 determines that the wireless device 100 is outside of the predetermined geo-fence, the device management center 300 establishes a two-way communication link between the wireless device 100 and the device management center 300. The device management center 300, in some embodiments, provides directions to the user's home, such that the user returns home. In some embodiments, the processor 148 also monitors the output from the electronic compass 120 to determine if the user is heading north, east, south, or west based on the user's current location. Similarly, the output from the accelerometer 116 may be monitored by the processor 148 to determine at what speed the wireless device 100 is moving (i.e., how fast the user is moving).

The processor 148 is also configured to determine the existence of a health emergency condition based on information from one or more biometric output provided by the biometric sensor 132. A health emergency condition is assumed to exist if one or more biometric outputs are outside of typical ranges. The processor 148 may determine a heart rate condition, a blood pressure condition, or a body temperature condition based on the output measured by the biometric sensor 132. The processor 148 then compares the output from the biometric sensor 132 to normal ranges (block 526). When the output from the biometric sensor 132 are outside of predetermined ranges for the heart rate, the blood pressure, or the body temperature, the processor 148 determines that the health emergency condition is present (block 528), which may be one of the heart rate condition, the blood pressure condition, and the body temperature condition. When the processor 148 determines the health emergency condition is present, the processor 148 sends the alert message to the device management center 300. The processor 148 may also specify in the alert message that the abnormal condition includes determination that the health emergency condition is present (block 506). In some embodiments, the output from the biometric sensor 132 is also used to more accurately determine when a different abnormal condition is present (e.g., to determine the existence and/or severity of the immobility condition).

The processor 148 is also configured to determine a low-charge or low battery condition indicating that the power supply 156 of the wireless device 100 has a low or reduced energy store. The processor 148 monitors the state of charge of the power supply 156 (e.g., battery state of charge) and compares the state of charge of the power supply 156 to a low-charge or low-battery threshold (block 530). When the state of charge of the power supply 156 drops below a predetermined battery threshold, the processor 148 determines that the battery condition is present (block 532) and sends an alert message to the device management center 300. The processor 148 may also specify in the alert message that the abnormal condition includes a determination that the state of charge of the power supply 156 is low (block 506). In some embodiments, the alert message sent to the device management center 300 indicating that the state-of-charge of the power supply 156 is low is referred to as a battery message since the message contains information regarding the battery 156 of the wireless device 100. In some embodiments, the processor 148 also activates the indicator 144 to alert the user that the state of the power supply 156 is low so that the user may replace or charge the power supply 156.

The processor 148 is also configured to determine an off condition indicative of the wireless device 100 being turned off. When the wireless device 100 begins to turn off because the power supply 156 is depleted and/or because a user turns off the wireless device 100 (block 534), the processor 148 determines or assumes the existence of an off condition (block 536). The wireless device 100 then sends an alert message to the device management center 300 indicating that the wireless device 100 is shutting down (block 506). The device management center 300 may then alert the recipients associated with the user and/or contact the user directly using an associated phone number or e-mail to find out why the wireless device 100 was turned off and when the user plans on turning on and/or charging the power supply 156 of the wireless device 100.

The processor 148 is also configured to determine when the panic button 108 is activated by the user. When the processor 148 determines that the panic button 108 has been activated, the processor 148 sends an alert message to the device management center 300. In some embodiments, the processor 148 may also send output associated with the accelerometer 116, the electronic compass 120, the temperature sensor 124, the GPS module 128, and the biometric sensor 132 to the device management center 300 to provide more information regarding the circumstances under which the user activated the panic button 108. In some embodiments, when the panic button 108 is activated, the microphone 136 and the speaker 140 are also activated to establish a communication link between the user of the wireless device 100 and the device management center 300 so that the device management center 300 may obtain more information about the situation and respond appropriately.

For example, an operator or administrator at the device management center 300 may want to ask the user why the panic button 108 was activated and what kind of help the user needs. If, for example, the panic button 108 was activated because the user fell, the device management center 300 may then contact a recipient associated with the user to inform that person that the user needs help. In another example, the user may activate the panic button 108 because the user has experience criminal activity (e.g., a burglar has entered the user's home). The device management center 300 may then contact the local police department directly. By activating the microphone 136 after the activation of the panic button 108, the device management center 300 is able to better analyze and respond to the particular emergency situation.

In some embodiments, output from more than one sensor 112, 116, 120, 124, 128, 132 are used to determine if an abnormal condition is present. For example, if a user is driving to a local healthcare facility that lies outside of the typical geo-fence, the accelerometer 116, the GPS module 128, and the electronic compass 120 may be used by the processor 148 to determine that the moving speed is greater than a typical walking pace. The processor 148 may then determine that the user must be driving and is no longer restricted to the predetermined geo-fence.

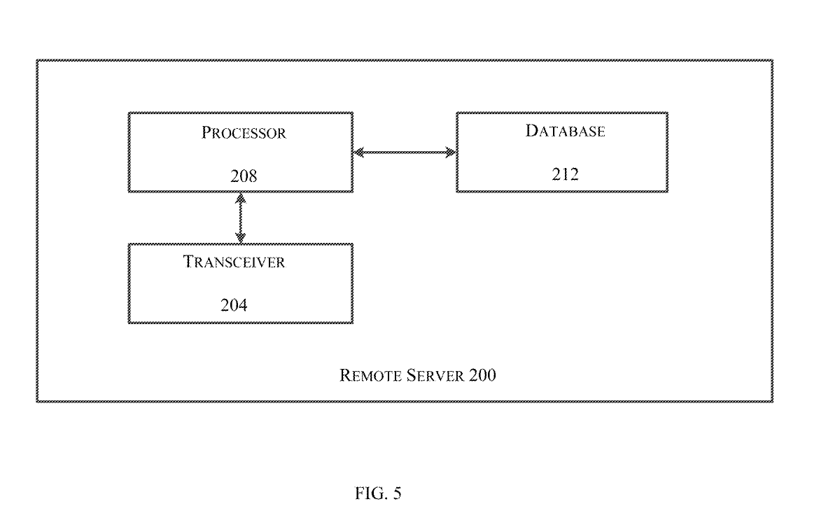

When the wireless device 100 sends an alert message to the device management center 300, the device management center 300 accesses the remote server 200. In some embodiments, the remote server 200 monitors a plurality of wireless devices 100. In such embodiments, each wireless device 100 is associated with a particular user and the remote server 200 is configured to monitor the communication between each wireless device 100 and respond to the alert messages sent by each wireless device 100. As shown in FIG. 5, the remote server 200 includes a transceiver 204, a processor 208, and a database 212. The transceiver 204 receives alert messages from the wireless device 100. In some embodiments, the transceiver 204 may communicate with the wireless device 100 by connecting to a network, for example the Internet. In other embodiments, the transceiver 204 may communicate with the wireless device 100 using a cellular network. In yet other embodiments, a different network may be used to communicate between the wireless device 100 and the remote server 200.

The database 212 is coupled to the processor 208 and stores information associated with the user. When the remote server 200 receives an alert message from the wireless device 100, the processor 148 accesses the database 212 to identify the user and to forward the alert message to the device management center 300. The device management center 300, after receiving the alert message, also accesses the database 212. The database 212 stores personal information associated with the user to identify the user when the alert message is received. For example, the database 212 includes identification information of the user. The identification information may be directly correlated with device identification information (e.g., a device serial number), such that the database 212 determines, based on the wireless device 100 used, the identity of the user. For example, a device identification number may be transmitted in the alert message; the database 212 then correlates the device identification number with a specific user associated with that device. In other embodiments, the user identification information may not be directly correlated with the wireless device 100 and the user may identify him- or her-self through a different method. For example, the user may program the wireless device 100 to include the user's name or a user identification number when sending the alert message to the remote server 200. The database 212 then identifies the user based on the user identification number or name and does not require device identification.

In addition, the database 212 stores a list of recipients associated with the user of the wireless device 100. The list of recipients may include relatives, friends, neighbors, healthcare professionals (e.g., a nurse or a doctor), and local emergency response agencies (e.g., police department, fire department, nearest hospital, and the like) that may be available to help the user if necessary. The list of recipients may include personal and contact information for each recipient such as, for example, a name, an address, a telephone number, an e-mail, a relationship to the user, and the like. The database 212 may also store information such as best form to contact the recipient, times of day during which the recipient is available, work and/or home location for the recipient, and the like. In embodiments where the database 212 stores local emergency response agencies in the list of recipients, the database 212 may store a name of the agency, jurisdiction of the agency, emergency and non-emergency phone numbers for the agency, and the like. In other embodiments, the local emergency response agency information is not stored in the database 212. Rather, when the alert message is received, the device management center 300 may look up the nearest emergency response agency to the user at that time and contact the appropriate agency. Thus, when the alert message is received, a quick decision is made regarding the best way to help the user and the best recipient to contact.

The database 212 may also store historical information for the user. For example, the database 212 stores how many alert messages have been received associated with the user, the dates and times associated with the received alert messages, which abnormal conditions were determined by the wireless device 100 to trigger the alert messages, the action taken by the device management center 300 to clear the alert messages, and the like. For example, the database 212 may also store a record of the device management center 300 communicating with one of the recipients associated with the user, or the device management center 300 communicating with a local emergency response agency (e.g., the fire department). The database 212 may also store information regarding the thresholds used by the wireless device 100 to determine abnormal conditions. For example, the database 212 stores the geo-fence threshold established for the wireless device 100, the time period used to determine the immobility condition, the low temperature threshold, the high temperature threshold, the acceleration threshold, the biometric thresholds, the state of charge threshold, and the like.

The database 212 also stores patterns associated with the user. For example, the database 212 may store an approximate time the user wakes up in the morning, an approximate time the user goes to bed in the evening, and the like. In addition to daily routines, the database 212 also stores daily, weekly, monthly, or annual activity levels. For example, the database 212 stores the number of daily steps taken by the user in the last week, last month, or last year. Similarly, the database 212 may store an average number of steps taken per week, per month, or per year. The processor 208 of the remote server 200 may then generate an alert message if the user breaks a pattern abruptly. For example, if the user for the past year has averaged approximately 7,000 steps daily and one day the user only takes 300 steps, the processor 208 generates an alert message and forwards the alert message to the device management center 300. The lack of activity of the user may be due, for example, to an injury that causes pain to the user when he/she walks or to the user feeling depressed, among other things. The processor 208 of the remoter server 200 determines the abrupt changes in routine of the user and alerts the device management center 300 that the user may be suffering from an abnormal condition (e.g., a broken foot or a depressed state of mind).

The database 212 may also store medical information regarding the user. The database 212 may store medical history associated with the user, for example, if the user has any history of heart attacks, asthma, severe allergies, or other medical condition. The database 212 may also store medications the user is currently taking and the schedule on which the medications are to be taken.

The processor 208 is coupled to the database 212 and to the transceiver 204. The processor 208 is configured to receive the alert messages from the wireless device 100, forward the alert messages to the device management center 300, and generate alert messages based on information received from the wireless device 100 and information stored in the database 212.

The device management center 300 includes an electronic device that has access to the remote server 200. The electronic device may access the remote server 200 through a network (i.e., the Internet or a cellular network). In some embodiments, the device management center 300 hosts the remote server 200 and shares the transceiver 204, the processor 208, and the database 212. The device management center 300 is configured to receive alert messages from the wireless device 100 through the remote server 200 and provide the necessary help to the user. The device management center 300 receives an alert message from the wireless device 100 when the wireless device 100 determines an abnormal condition is present. The device management center 300 then uses information stored in the database 212 to correctly identify the user and determine an appropriate action. In some embodiments, the device management center 300 includes a plurality of operators that access the remote server 200 through the electronic device. The operators receive the alert messages from the wireless device 100 and determine based on the information provided what the best course of action may be. In other embodiments, the device management center 300 does not include operators and performs the described functionality automatically (i.e., using software programs to execute decision making, establishing communication links, and updating alert messages as necessary).

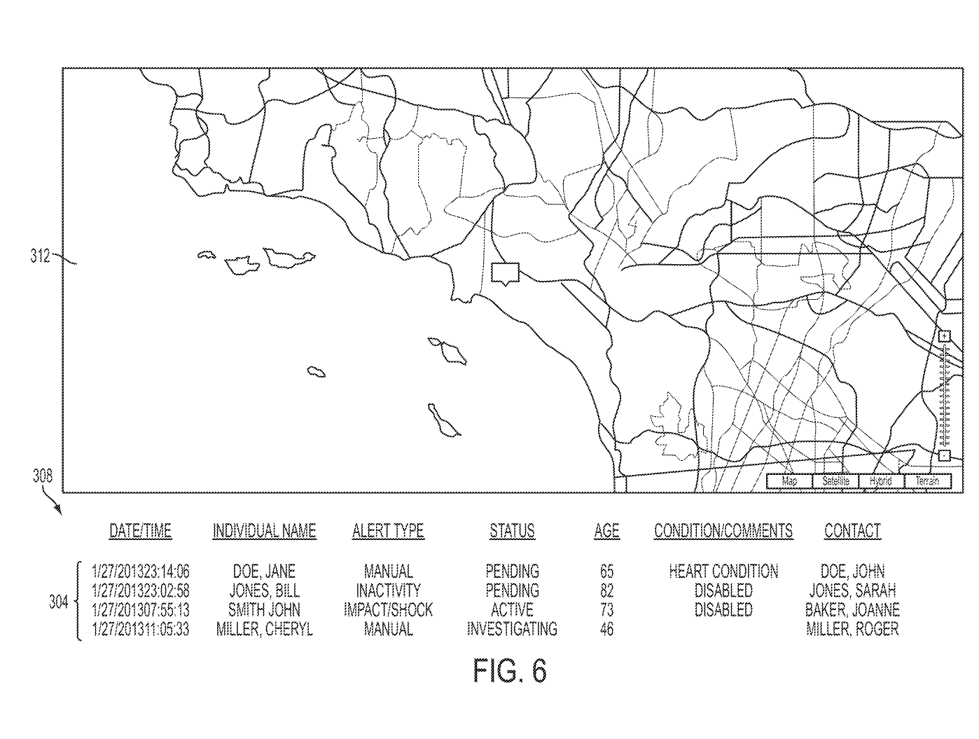

FIG. 6 shows an exemplary screenshot of a graphical user interface displayed on the electronic device used at the device management center 300. As shown in FIG. 6, the device management center 300 receives several alert messages 304 from multiple wireless devices 100, each associated with an individual user. Each alert message 304 is displayed in a table 308. The table 308 includes information such as the date and time of the received alert message 304, a user associated with the alert message 304, an alert type (e.g., an abnormal condition determined), a status of the alert message 304, relevant comments, and a primary recipient associated with the user. Thus, the table 308 provides clear and concise information to the device management center operators and/or to a processor of the device management center 300. As also shown in FIG. 6, a map display 312 is shown so that the location of the wireless device 100 generating the alert message 304 is quickly determined.

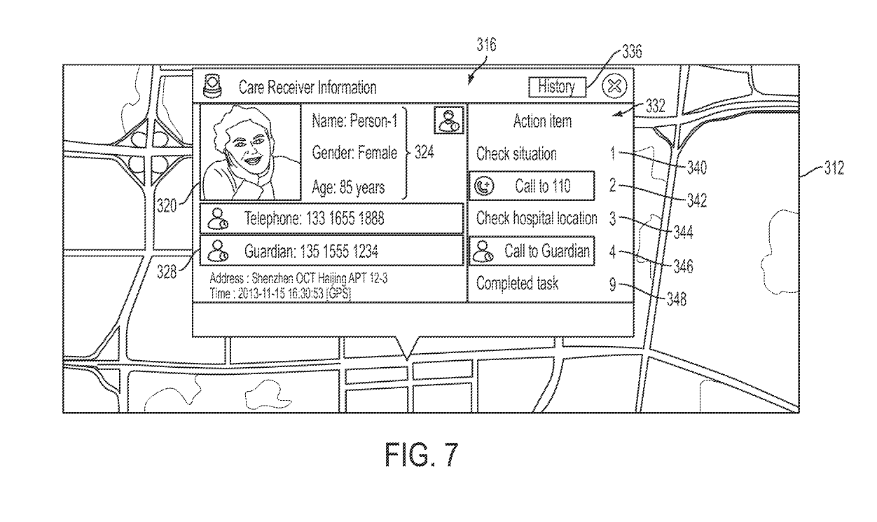

A particular alert message 304 may be chosen (e.g., clicked) from the table 308 to view more detailed information regarding the emergency, the user, the status of the alert message, and the recipient associated with the user. As shown in FIG. 7, when an alert message 304 is selected from the table 308, a detail screen 316 is displayed. The detail screen 316 includes an image identifier 320, personal information 324, contact information 328 for a primary recipient, a status section 332, and a history tab 336. The image identifier 320 is generally a picture of the user of the wireless device 100. In some embodiments, the image identifier 320 is a picture associated with the user, but not of the user. For example, the image identifier 320 may be a picture of a pet, a family photo, a particular landscape, and the like. The personal information 324 is used by the device management center 300 to identify a user and quickly acquire an idea of the emergency the user may be experiencing. The personal information 324 also allows the device management center 300 to forward necessary personal information to local emergency response agencies if needed. The personal information 324 is populated on the detail screen 316 by the database 212.

The detail screen 316 also displays contact information 328 for a primary recipient. In the illustrated embodiment, the contact information 328 includes a telephone number, but other contact information may alternatively or additionally be included in the detail screen 316. For example, if the primary recipient does not have a telephone number, or if the primary recipient prefers to be contacted by e-mail, an e-mail address may be displayed. The status section 332 allows an operator of the device management center 300 to change the status of an alert message 304. The status section 332 includes various action items that indicate an action by the device management center 300. In the illustrated embodiment, the action items are displayed in the order in which they are expected to occur. For example, when an alert message 304 is received by the device management center 300, a “check situation” status 340 is assigned to the alert message 304. The “check situation” status 340 may include verifying the abnormal condition determined to be present by the wireless device 100 and/or verifying the sensor output associated with the abnormal condition. Once the situation has been verified, the device management center 300 may establish a communication link with the wireless device 100, determine the location of the nearest emergency response agency, or contact the primary recipient associated with the user. Depending on the type of alert message 304, the device management center 300 executes one or more of the above-listed actions. When the device management center 300, or an operator of the device management center 300, executes the action, an appropriate action item is selected. For example, if the device management center 300 establishes a communication link with the wireless device, the “call to 110” status 342 is selected. Alternatively, or additionally, if a near emergency response agency is searched, the “check hospital location” status 344 is selected. If, or when, the device management center 300 contacts the primary recipient, the “Call to Guardian” status 346 is selected. Finally, when the abnormal condition has been resolved by the user, an emergency response agency, and/or a recipient associated with the user, a “completed task” status 348 is selected and the alert message 304 is cleared and stored. Thus, the device management center 300 is able to monitor and track the device management center's response to the alert messages 304. In some embodiments, the device management center 300 may escalate the alert messages 304 in priority based on the amount of time they have remained open.

The history tab 336 provides historical information regarding the user. The historical information may include past alert messages 304 received from the same user and how they were resolved by the device management center 300. The historical information may alternatively or additionally include historical medical information such as, for example, past medical conditions or medical emergencies. By navigating between the table 308 and the detail screen 316, the device management center 300 is able to respond to the alert messages 304 received from different wireless devices 100.

The recipients associated with the user may each have a recipient device 400. The recipient device 400 may be for example, a smartphone, a smartwatch, a tablet computer, a cellphone, or other electronic device capable of accessing the remote server 200 through a network such as, for example, the Internet or a cellular network. In the illustrated embodiment, the recipient device 400 is a smartphone.

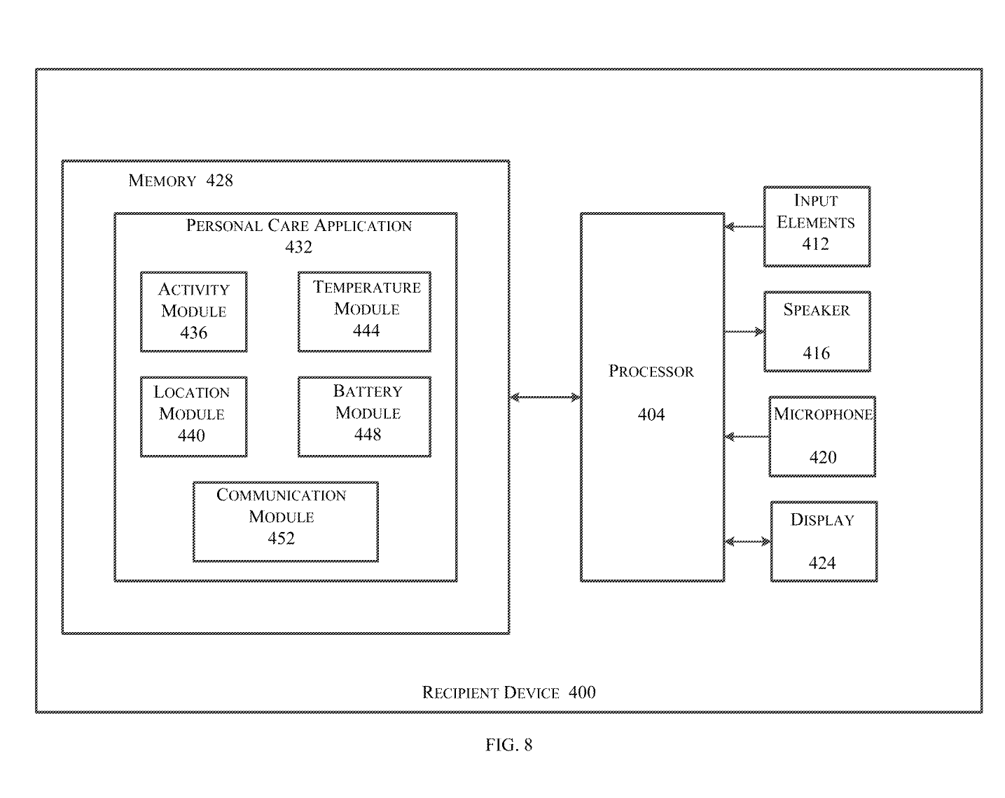

As shown in FIG. 8, the recipient device 400 includes a processor 404, input elements 412, a speaker 416, a microphone 420, a display 424, and memory 428. The input elements 412 may include buttons, switches, sensors (e.g., a touchscreen), and the like. The input elements 412 enable a user to control the functionality of the recipient device 400. The microphone 420 may be used by the recipient device 400 to receive sound signals. The sounds signals may be used by the recipient device as instructions to be fulfilled by the processor 404, or the sound signals may be transmitted to another electronic device. The speaker 416 allows the recipient device 400 to output signals to a user. For example, the speaker 416 of the recipient device 400 may be used by the personal emergency response system 1000 to alert a recipient (e.g., a user of the recipient device 400) of an emergency associated with the user of the wireless device 100. In other embodiments, the recipient device 400 may also include other output elements such as, for example, a vibrating element. The memory 428 of the recipient device 400 includes non-transitory computer readable medium in which data and instructions for use by the processor 404 of the recipient device 400 are stored.

The recipient device 400 hosts a personal care application 432 in memory 428. In some embodiments the personal care application 432 may be hosted directly on the recipient device 400. In other embodiments, the recipient device 400 connects to a network, for example the Internet, to access the personal care application 432. In yet other embodiments, some aspects of the personal care application 432 are hosted by the recipient device 400 and other aspects of the personal care application 432 are accessed through a network. The personal care application 432 includes an activity module 436, a location module 440, a temperature module 444, a battery module 448, and a communication module 452. Each module 436, 440, 444, 448, 452 obtains information from the remote server 200. The personal care application 432 generates a graphical user interface 456 that is displayed on the recipient device 400 to display the information obtained through each of the modules 436, 440, 444, 448, 452.

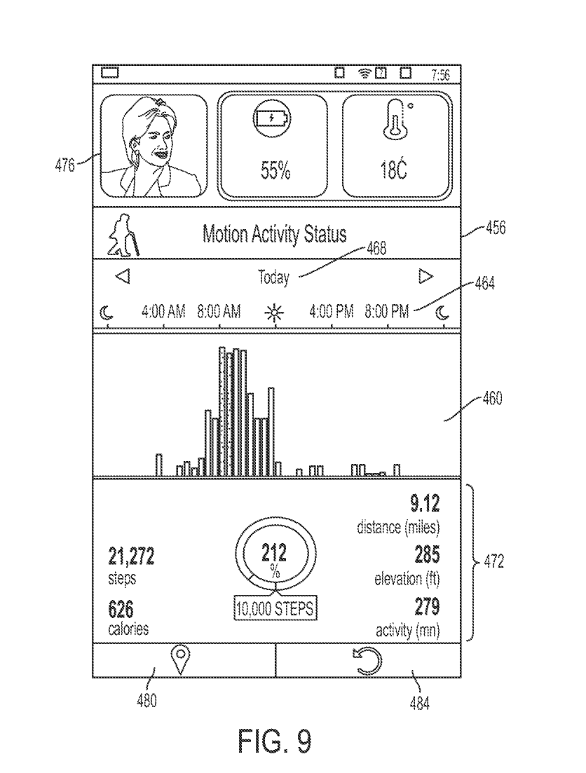

FIG. 9 illustrates an exemplary screenshot of the personal care application 432. The graphical user interface 456 includes a graph 460 to display the activity of the user of the wireless device 100 as obtained by the activity module 436. The remote server 200 relays information obtained from the accelerometer 116 regarding the number of steps taken by the user of the wireless device 100 to the activity module 436. The personal care application 432 displays the user's steps in the form of a bar graph 460. The personal care application 432 also displays a timeline 464 that allows a recipient to note the times of the day when the user of the wireless device 100 is active. In other embodiments, the graphical user interface 456 may display the activity of the user of the wireless device 100 in a different format with or without a graph and/or a timeline. The recipient may also wish to see the user's activity for a past day and may change a day identifier 468 to select a past day to view the activity graph 460 associated with the past day selected by the recipient. The graphical user interface 456 may also display other activity metrics 472. In the illustrated embodiment, the activity metrics 472 include total number of steps taken, calories burned, distance covered, time spent active, and a percentage of steps with respect to a reference quantity. In other embodiments, the activity metrics 472 may not be displayed or different activity metrics 472 may be displayed.

The graphical user interface 456 generated by the personal care application 432 also displays the current ambient temperature associated with the wireless device 100 as obtained by the temperature module 444. The temperature module 444 connects to the remote server 200 to obtain the current ambient temperature determined by the wireless device 100. The graphical user interface 456 also displays a current battery status associated with the wireless device 100 as obtained by the battery module 448. The battery module 448 connects to the remote server 200 to obtain the current state of charge of the power supply 156 of the wireless device 100.

If any of the metrics (e.g., the steps taken, the ambient temperature, and the battery status) displayed to the recipient seem abnormal to the recipient, the recipient may choose to contact the user of the wireless device 100 directly. The graphical user interface 456 includes a call button 476. By activating the call button 476 the personal care application 432 establishes a communication link between the user of the wireless device 100 and the recipient. In some embodiments, the communication link connects the recipient device 400 with the wireless device 100 directly.

The graphical user interface 456 also includes a refresh button 484 and a map view button 480. The refresh button 484 is activated to request updated information to be displayed on the graphical user interface 456. In some embodiments, the graphical user interface 456 displays old information (i.e., information from the last time the refresh button 484 was activated) until the refresh button 484 is activated. In such embodiments, the personal care application 432 sends a request to the remote server 200 for updated information when the refresh button 484 is activated. The remote server 200 in turn sends a request to the wireless device 100 for updated information. The wireless device 100 may then send a message to the remote server 200 with updated sensor information. Therefore, the wireless device 100 communicates with the remote server 200 when the wireless device 100 determines an abnormal condition and when the remote server 200 requests uploaded information.

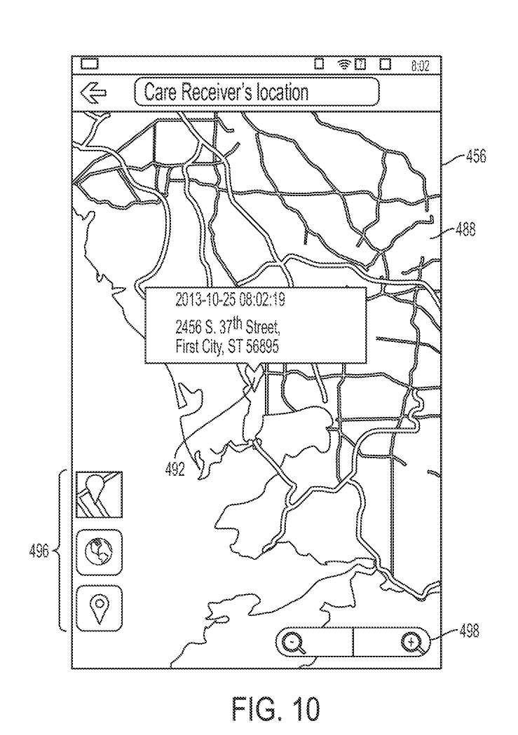

The map view button 480 displays updated location information for the wireless device 100. When the map view button 480 is activated a map view 488 is displayed, as shown in FIG. 10. The map view 488 displays the current location of the wireless device 100 with a pin 492 and associated text. The associated text may provide additional information such as, for example, a date and time when the location information was obtained, and address associated with the location, and any notes the user of the wireless device 100 or the recipient may have associated with a particular place. The map view 488 also includes different view icons 496. The view icons 496 may be activated to change the current view of the map view 488. For example, the view icons 496 allow a user to change between a typical map view to a satellite view or a traffic view. The map view 488 also includes zoom button 498 that allows more detail near the pin 492 to be displayed. Thus, the map view 488 provides clear and detailed location information for the wireless device 100. The personal emergency response system 1000 is configured to provide quick assistance to a user of the wireless device 100.

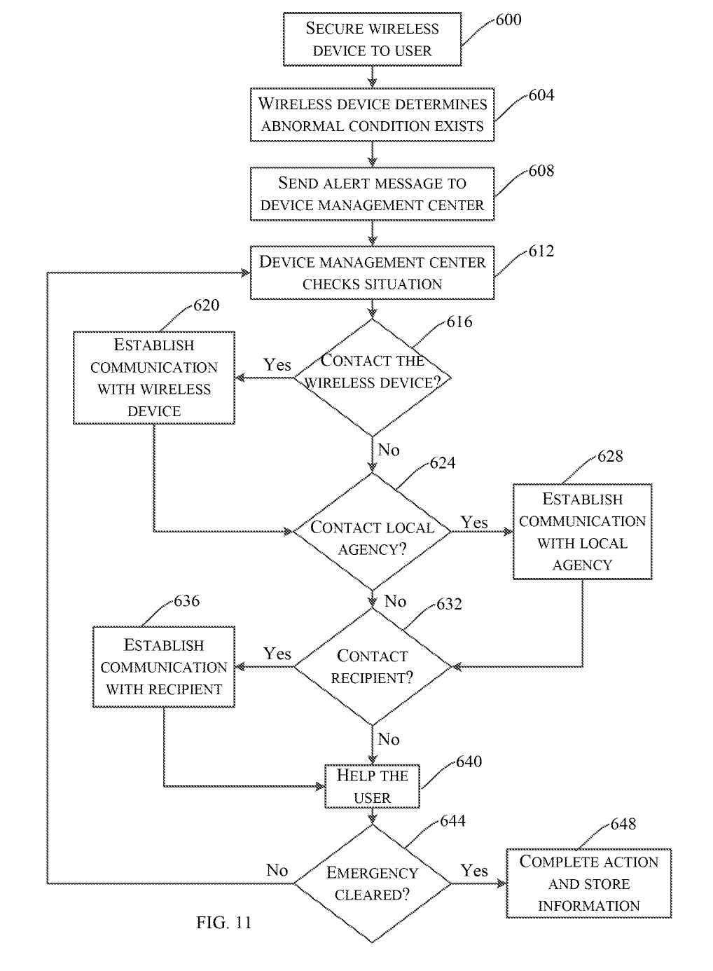

FIG. 11 illustrates an exemplary flowchart showing a simple method for operating the personal emergency response system 1000. First, the user secures the wireless device 100 to the user (block 600). The wireless device 100 then monitors the signals from various sensors 112, 116, 120, 124, 128, 132 to obtain information related to the wireless device 100 and indicative of the well-being of the user. The wireless device 100 then determines the existence of an abnormal condition based on the output from the sensors 112, 116, 120, 124, 128, 132 (block 604). After the wireless device 100 determines that the abnormal condition exists, the wireless device 100 sends an alert message to the device management center 300 through the remote server 200 including information regarding the abnormal condition (block 608). The device management center 300 proceeds to investigate the situation (block 612). Investigating the situation may include, for example, identifying the abnormal condition determined to be present by the wireless device 100.

In some embodiments, the device management center 300 sends a notification to the recipient through the personal care application 432. The recipient device 400 may alert the recipient of a received notification indicating an abnormal condition determined by the wireless device 100. The recipient device 400 may use the speaker 416, the display 424, a vibrating element, or a combination thereof to alert the recipient of the received notification. The recipient may then respond to the notification. In other embodiments, the device management center 300 does not contact the recipient through the personal care application 432. Rather, the device management center 300 contacts the recipient by a different communication method.

The device management center 300 determines an appropriate course of action based on, for example, the abnormal condition determined to be present, the time of day, the location of the user, and the like. The device management center 300 determines whether or not to contact the user of the wireless device 100 directly to obtain more information (block 616). If the device management center 300 decides to contact the user, the device management center 300 establishes a communication link with the wireless device 100 using, for example, the microphone 136 and the speaker 140 (block 620). Then the device management center 300 determines whether the situation is sufficiently grave to contact a local emergency response agency (block 624). If so, the device management center 300 establishes a communication link with the local emergency response agency (block 628). Then the device management center 300 determines whether a recipient associated with the user should be notified of the situation (block 632). If the device management center 300 determines that the recipient should be notified, the device management center 300 establishes a communication link with the recipient (block 636). The user of the wireless device 100 then receives the help needed through a recipient and/or the local emergency agency (block 640). The device management center 300 tracks the status of the alert message 304 and determines if the emergency has been cleared (block 644). If the emergency has been cleared and the user has received the help needed, the device management center 300 completes the action and stores the associated information in the database 212 (block 648). If, for some reason, the emergency is not cleared and the user has not received help, the device management center 300 continues to monitor the situation and communicates with the necessary parties (i.e., the recipients and/or the local emergency agencies) until the emergency is cleared.

Thus, the invention provides, among other things, a personal emergency response system that monitors different parameters associated with a user and sends an alert message when an abnormal condition is determined. Various features and advantages of the invention are set forth in the following claims.

What is claimed is:

1. A wireless device comprising:
a transceiver configured to communicate with a device management center;
a first sensor configured to detect a parameter associated with the wireless device;
a second sensor configured to detect a position associated with the wireless device; and
a processor coupled to the transceiver, the first sensor, and the second sensor and configured to:
determine an abnormal condition related to the wireless device by receiving a first output from one of the first sensor and the second sensor, and comparing the first output to a threshold value; and
send an alert message to a device management center including information related to the abnormal condition.

2. The wireless device of claim 1, wherein the first sensor includes an accelerometer configured to detect movement of the wireless device, and wherein the processor is configured to receive the first output from the accelerometer and compare the first output to an acceleration threshold to determine a sudden impact condition.

3. The wireless device of claim 1, wherein the first sensor includes a temperature sensor configured to detect ambient temperature around the wireless device, and wherein the processor is configured to receive the first output from the temperature sensor and compare the first output to a temperature threshold to determine one of a cold condition and a hot condition.

4. The wireless device of claim 1, wherein the first sensor includes an electronic compass configured to detect angular movement of the wireless device.

5. The wireless device of claim 1, further comprising a battery for providing power to the wireless device, and wherein the processor is configured to determine a battery condition associated with the state of charge of the battery and send the alert message to the device management center including information related to the battery condition.

6. The wireless device of claim 5, wherein the processor is configured to send the alert message to the device management center when the battery state of charge is below a predetermined threshold.

7. The wireless device of claim 1, wherein the processor is configured to receive the first output from the second sensor, and compare the first output to a position threshold, wherein the position threshold is based on a predetermined perimeter around an area, such that the processor is configured to determine that the wireless device is outside of the predetermined perimeter around the area when the first output exceeds the position threshold.

8. The wireless device of claim 1, wherein the processor is configured to receive the first output from the first sensor and receive a second output from the second sensor, wherein the processor uses information derived from the first output and the second output to determine the abnormal condition.

9. The wireless device of claim 1, further comprising a panic button, wherein the processor is configured to send the alert message to the device management center when the panic button is activated.

10. The wireless device of claim 1, further comprising a microphone and a speaker, wherein the processor is configured to enable two-way communication between the device management center and the wireless device by activating the microphone and the speaker.

11. The wireless device of claim 1, wherein the wireless device is a wearable device.

12. The wireless device of claim 1, wherein the first sensor includes a proximity sensor configured to detect whether the wireless device is near a docking station.

13. The wireless device of claim 12, wherein the second sensor is disabled while the proximity sensor detects that the wireless device is near the docking station.

14. The wireless device of claim 1, further comprising a biometric sensor configured to detect a biometric characteristic associated with a user of the wireless device, and wherein the processor is configured to compare the biometric output to a threshold.

15. The wireless device of claim 1, wherein the processor sends the alert message to the device management center when the wireless device is shutting down.

16. A personal emergency system comprising:
a wireless device including
a first transceiver,
a first sensor configured to detect a parameter associated with the wireless device,
a second sensor configured to detect a position associated with the wireless device,
a first processor coupled to the transceiver, the first sensor, and the second sensor and configured to
receive an output from one of the first sensor and the second sensor,
determine if an abnormal condition exists based on the output, and
generate an alert message when the abnormal condition exists; and
a remote server including
a second transceiver configured to communicate with the wireless device,
a database including information associated with a user of the personal emergency system, and
a second processor coupled to the database and the second transceiver, the processor configured to
receive the alert message from the wireless device including information regarding the abnormal condition, and
access the database based on the alert message.

17. The personal emergency system of claim 16, wherein the database includes identification information of the user and recipients associated with the user.

18. The personal emergency system of claim 17, further comprising a device management center configured to receive the alert message and contact a recipient associated with the user.

19. The personal emergency system of claim 18, wherein the device management center includes the remote server.

20. The personal emergency system of claim 16, wherein the alert message includes information associated with a user, and wherein the second processor identifies the user based on information from the alert message.

21. The personal emergency system of claim 16, wherein the wireless device further includes a battery to power the wireless device, and wherein the first processor is configured to monitor a state of charge of the battery and send a battery message to the remote server when the state of charge of the battery is below a predetermined threshold, and wherein the second processor is configured to send a response message to the wireless device to alert a user to replace the battery.

22. The personal emergency system of claim 16, further comprising a recipient device configured to communicate with the remote server and display information regarding one of the parameter and the position associated with the wireless device.

23. The personal emergency system of claims 22, wherein the recipient device is further configured to establish a communication link with the wireless device.
